(19) United States
(12) Patent Application Publication
(10) Pub. No.: US 2007/0235947 A1
(43) Pub. Date: Oct. 11, 2007

(54) FIXABLE FLANGE GASKET

(76) Inventors: Heiko MEIER, Rahden (DE); Klaus OLEJARZ, Loehne (DE); Frank QUAST, Bielefeld (DE); Martin SCHMIDT, Luebbecke (DE)

Correspondence Address: Norman P. Soloway;HAYES SOLOWAY P.C., Suite 140, 3450 E. Sunrise Drive, Tucson, AZ, 85718, US

(21) Appl. No.: 11/765,333

(22) Filed: Jun. 19, 2007

Related U.S. Application Data
(62) Division of application No. 11/253,378, filed on Oct. 19, 2005.

(30) Foreign Application Priority Data
Nov. 12, 2004 (DE) 20 2004 017 562.2

(51) Int. Cl. F16J 15/02

(52) U.S. Cl. 277/616

(57) ABSTRACT

In order to seal a housing that is provided with a flange for connection to a wall cutout or another flange, there is provided a flange gasket with collars that protrude from the material plane of the flange gasket and are arranged in the region of mounting holes in the flange, wherein mounting screws may be inserted into the openings of said collars and held therein at least until the installation of the flange.

### FIELD OF THE INVENTION

The invention pertains to a fixable flange gasket for sealing a housing that is provided with a flange and needs to be connected to a wall cutout or another connecting flange.

### BACKGROUND OF THE INVENTION

A flange gasket of this type is used for installing a housing or the like that is provided with a flange in any desired fitting position, namely such that the required mounting screws cannot fall out of the mounting holes.

It is common practice to cut flange gaskets of this type such that they are precisely fitted to the respective flange, wherein the openings for the mounting screws correspond to those in the flange. This means that the mounting screws for rigidly connecting the flanges can be effortlessly pushed through these openings.

However, the installation in any desired fitting position is quite difficult with a thusly designed flange gasket because the object to be mounted, the flange gasket and the mounting screws need to be somehow held together and mounted with the aid of the mounting screws.

### SUMMARY OF THE INVENTION

The invention is based on the objective of designing a flange gasket of the initially described type for use on a housing in such a way that the installation is simplified by holding the mounting screws in the openings in the flange gasket.

According to the invention, this objective is attained in that collars protruding from the plane of the flange [gasket] material are arranged on the flange gasket in the region of the flange mounting holes, and in that the mounting screws can be inserted into the openings of said collars.

Advantageous embodiments of invention are disclosed in claims 2-5.

The advantages attained with the invention can be seen, in particular, in that the housing and the flange gasket with the mounting screws pre-installed therein form a unit that can be installed in any desired installation or fitting position, namely because the mounting screws are prevented from falling out of the mounting holes of the flange even if the unit is installed overhead.

The mounting screws can be advantageously inserted into the openings of the collars that protrude from the plane of the flange gasket material and are arranged congruently with the mounting holes in the flange.

It is also advantageous to provide at least one sealing lip on the inner wall of the collars in order to secure the mounting screws from falling out.

The mounting holes corresponding to the respective collars of the flange gasket have a correspondingly adapted or widened diameter such that the flange gasket is already held in the mounting holes when it is joined with the flange. It is also proposed to manufacture the flange gasket in the form of a moulded article in order to allow the utilization of optimal materials.

The screws and the flange gasket are fixed on the flange of a connector housing that is not described in greater detail such that the installation of such a housing on a corresponding mounting part is significantly simplified.

### BRIEF DESCRIPTION OF THE DRAWINGS

One embodiment of the invention is illustrated in the figures and described in greater detail below. The figures show:

FIG. 1, a perspective representation of a flanged connector housing and a flange gasket spaced apart therefrom;

FIG. 2, a perspective representation of a flange gasket with a flange housing spaced apart therefrom, and

FIG. 3, a section through a mounting hole in the flanged housing with a mounting screw inserted therein.

### DETAIL DESCRIPTION OF THE INVENTION

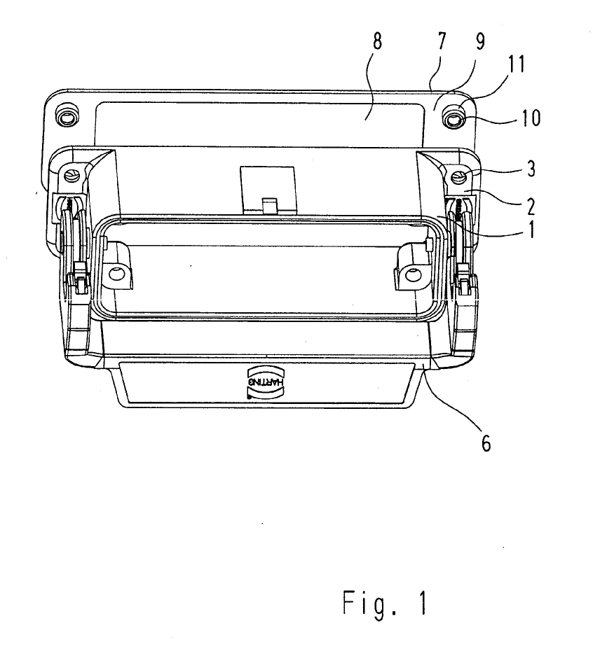

FIG. 1 shows a connector housing 1 with a flange 2 in the form of a perspective representation of the open connecting side of the connector.

Due to the chosen viewing angle, a flange gasket 7 is visible behind the housing 1, wherein this flange gasket serves for producing an absolutely tight connection with a not-shown housing or another flange. In addition to the cutout 8 for the cables leading out of the connector, the flange gasket 7 also contains openings 10 for mounting screws that are respectively surrounded by a collar 11 protruding from the material plane 9 of the flange gasket 7.

This figure also shows a clip 6 for producing a separable connection with a not-shown mating connector.

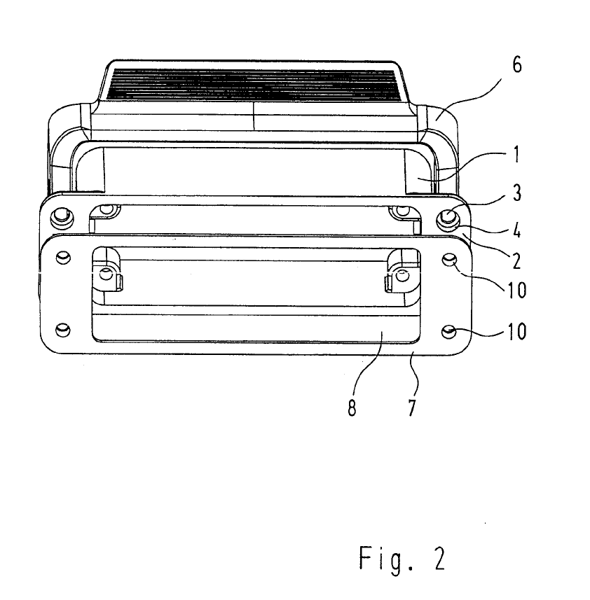

FIG. 2 also shows a perspective representation, however, of the opposite side of the flange gasket 7 and the housing 1 referred to FIG. 1.

This figure clearly shows the cutout 8 as well as the arrangement of the openings 10 in the flange gasket 7.

The mounting holes 3 in the flange 2 of the housing for accommodating the mounting screws are provided with a region 4 of increased diameter, wherein the collar 11 of the flange gasket 7 protrudes into this widened region. In this case, the diameters of the opening 4 and of the collar 11 are chosen such that the flange gasket is already fixed on the flange when the collars are inserted into the openings 4.

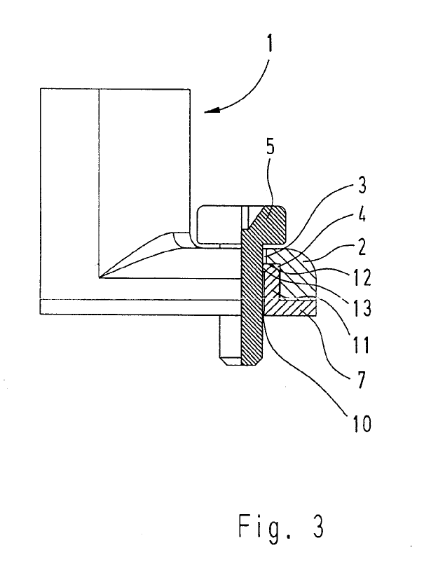

FIG. 3 shows an enlarged partial section through one of the mounting holes 3 in the flange 2 with a mounting screw 5 inserted therein.

The flange gasket 7 is placed on the flange 2 of the housing 1 in a precisely fitted fashion, wherein the collars 11 of the flange gasket penetrate into the widened regions 4 of the mounting holes 3 in the flange. These widened regions 4 are absolutely imperative for a thusly designed flange gasket.

FIG. 3 also shows an inner sealing lip 13 that is integrally moulded onto the collar end 12 and tightly adjoins the shaft of the mounting screw 5 such the mounting screw is prevented from falling out and a sealing effect is simultaneously achieved.

1-9. (canceled)

10. A flexible flange gasket for use with a flanged housing and gasket assembly for mounting to a wall or another flanged member, using mounting screws that extend through screw mounting holes in the flanged housing and gasket assembly, wherein the gasket includes a collar extending from the gasket surrounding each screw mounting hole, said collar having an outer diameter sized to snuggly fit in screw mounting holes in the flanged housing, and an inner lip protruding into the screw mounting hole sized to accommodate a screw and prevent the screw from falling out.

11. The flexible flange gasket according to claim 10, wherein the inner lip is integrally moulded to the collar.

12. The flexible flange gasket according to claim 10, wherein mounting screws are installed.
